(19) United States
(12) Patent Application Publication
(10) Pub. No.: US 2001/0046846 A1
(43) Pub. Date: Nov. 29, 2001

(54) Mobile terminal and reception gain control method in mobile terminal

(75) Inventor: Soichi Tsumura, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/818,920

(22) Filed: Mar. 27, 2001

(30) Foreign Application Priority Data
Mar. 29, 2000 (JP) 2000-091745

(51) Int. Cl. H04B 1/06

(52) U.S. Cl. 455/240.1; 455/234.1; 455/239.1

(57) ABSTRACT

A baseband signal processing means for performing baseband processing of a received signal produces and updates a gain control signal for controlling gain used in a gain varying means. Time intervals for the update of the gain control signal are set on the basis of a rate of change over time in the power level of the received signal. As an absolute value of a slope of an amount of change in the power level of the received signal per unit time is larger, a shorter time interval for the update of the gain control signal is set. As an absolute value of a slope of an amount of change in the power level of the received signal per unit time is smaller, a longer time interval for the update of the gain control signal is set.

### BACKGROUND OF THE INVENTION

1. Field of the Invention

The present invention relates to a mobile terminal for use in a mobile communication system and a reception gain control method in the mobile terminal, and more particularly to a mobile terminal having a gain varying section with a substantially log-linear gain control characteristic (which realizes linear gain changes with respect to changes in a control signal when gain is represented by logarithm), and a reception gain control method in the mobile terminal.

2. Description of the Related Art

As a mobile terminal for use in a mobile communication system moves, the distance between the mobile terminal and a base station is changed. The mobile terminal thus supports a reception power level varying in a wide range, for example, from 70 to 100 dB.

For this reason, conventional digital mobile communication employs a so-called constant amplitude digital modulation scheme in which communication is performed by carrying information, for example on the frequency of a signal rather than the amplitude thereof to handle the aforementioned variations in the reception power level through the use of a limiter amplifier.

In recent mobile communication systems, however, lack of frequency resources caused by an increased number of users of mobile communication advances the commercialization of digital mobile communication systems which potentially have high efficiency of frequency utilization and use a linear digital modulation scheme typified by QPSK, and the use of the limiter amplifier is made difficult. Particularly, in a W-CDMA (Wide Band Code Division Multiple Access) communication system receiving attention as a next-generation mobile communication system, since communication is performed by extracting an intended signal from a plurality of signals multiplexed on the amplitude, it is not possible to use the limiter amplifier with which information on the amplitude is lost.

It is thus necessary to use a gain varying amplifier capable of handling a wide variation range of a reception power level as mentioned above on the side of a mobile terminal. To meet this need, a gain varying amplifier which produces substantially linear changes in gain represented by logarithm with respect to changes in a control signal is typically used because its gain can be varied in an extremely wide range.

On the other hand, a transmission path in land mobile communication serves as multiple waves propagation path due to reflection from buildings and the like present around a mobile terminal. In this case, interference of multiple waves forms a distribution of an electromagnetic field with random stationariness.

When a mobile terminal moves in an electromagnetic field distribution with a random stationariness during communication, the reception power level in the mobile terminal is randomly changed over time as a result.

As shown in FIG. 1, when a mobile terminal moves on a multiple wave propagation path, the reception power level is randomly changed in the mobile terminal associated with the move.

It is thus necessary to control amplification gain of a received signal in the mobile terminal in accordance with the changing reception power level associated with the move such that the reception power level in the mobile terminal approaches a predetermined target value.

If the reception power level of a signal received in the mobile terminal is changed over time as shown in FIG. 2a, the gain value is increased at times when the reception power level is low, while the gain value is reduced at times when the reception power level is high in the mobile terminal as shown in FIG. 2b. Such an operation is performed to approach the reception power level to the predetermined target value. The gain values for approaching the reception power level to the target value are set on the basis of the reception power levels for each of certain time periods as shown in FIG. 2b.

However, in the aforementioned conventional reception gain control method in a mobile terminal, since the gain values for approaching the reception power level to the target value are set for the respective time periods, an abrupt change in the reception signal level as that near time a shown in FIG. 2a cannot be followed by the control of the gain value. Consequently, a large error occurs between the reception power level after the gain control and the target value as shown in FIG. 2c.

Compensation for such a large error in gain control typically requires a large number of bits resulting from quantization in an A/D converter provided after a gain control section. In this case, a problem of difficulties in providing a smaller size and reduced power consumption of the entire device is presented.

### SUMMARY OF THE INVENTION

It is an object of the present invention to provide a mobile terminal which can achieve a smaller size and reduced power consumption of a device by reducing an error between a reception power level after gain control and a target value, and a reception gain control method in the mobile terminal.

In the present invention, a baseband signal processing means for performing baseband processing of a received signal produces and updates a gain control signal for controlling gain used in a gain varying means. Time intervals for the update of the gain control signal are set on the basis of a rate of change over time in the power level of the received signal. As an absolute value of a slope of an amount of change in the power level of the received signal per unit time is larger, a shorter time interval for the update of the gain control signal is set. As an absolute value of a slope of an amount of change in the power level of the received signal per unit time is smaller, a longer time interval for the update of the gain control signal is set.

With such settings, even when an abrupt change occurs in the reception power level, the gain value in the gain varying means is controlled following that change in the reception power level, thereby providing a power level of the received signal amplified in the gain varying means with a small error from a target value.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a graph showing an example of variations in reception power level over time in a mobile terminal moving on a multiple wave propagation path;

FIG. 2a is a graph showing variations in reception power level over time for describing a reception gain control method in a conventional mobile terminal;

FIG. 2b is a graph showing gain values based on the reception power level shown in FIG. 2a;

FIG. 2c is a graph showing power levels of a received signal controlled by the gains shown in FIG. 2b;

FIG. 3 is a block diagram showing an embodiment of a receiving section in a mobile terminal of the present invention;

FIG. 4a is a graph showing reception power levels of a signal received at a radio section shown in FIG. 3;

FIG. 4b is a graph showing gain values in a gain varying section controlled by a gain control signal shown in FIG. 3;

FIG. 4c is a graph showing power levels of a signal output from the gain varying section shown in FIG. 3;

FIG. 5a is a graph showing reception power levels of a signal received at the radio section shown in FIG. 3;

FIG. 5b is a graph showing gain values in the gain varying section controlled by the gain control signal shown in FIG. 3; and

FIG. 5c is a graph showing power levels of a signal output from the gain varying section shown in FIG. 3.

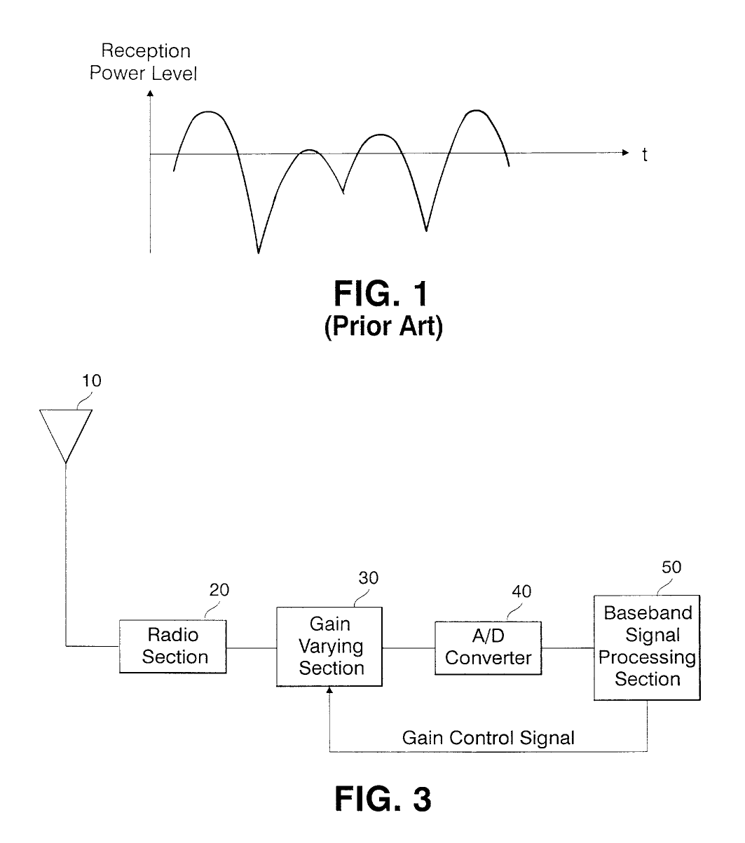

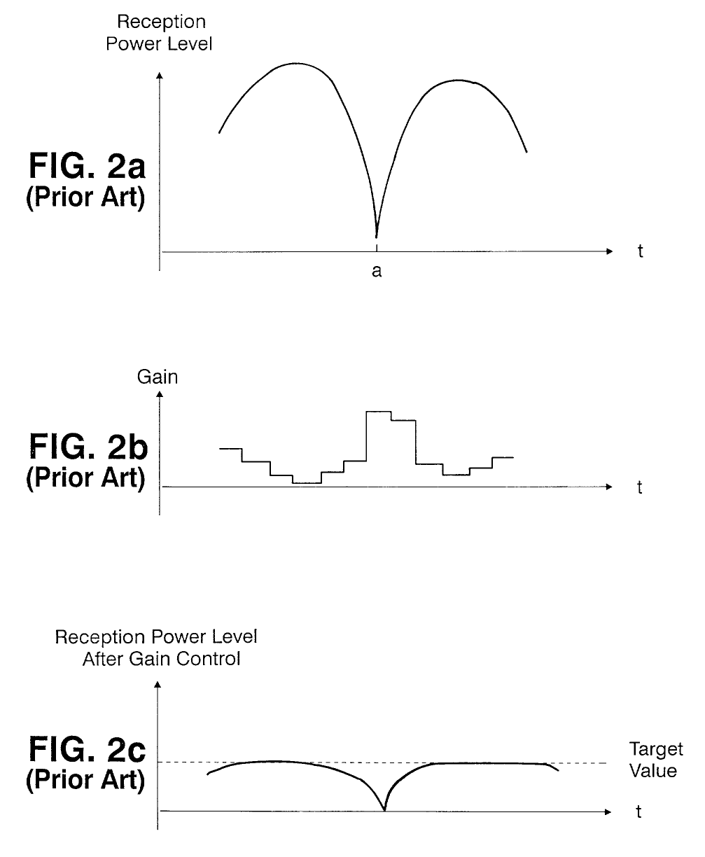

### DETAILED DESCRIPTION OF THE PREFERRED EMBODIMENTS

A mobile terminal according to a preferred embodiment of the present invention comprises antenna 10 for transmitting and receiving radio wave signals, radio section 20 for receiving a signal destined for the mobile terminal of the radio wave signals received at antenna 10, gain varying section 30 which has a substantial log-linear gain control characteristic (which realizes linear gain changes with respect to changes in a control signal when gain is represented by logarithm) and amplifies the signal received at radio section 20 with gain based on a gain control signal, A/D converter 40 for converting the received signal amplified by gain varying section 30 into a digital signal and outputting the converted signal, and baseband signal processing section 50 for performing baseband processing of the digital signal output from A/D converter 40, producing the gain control signal for controlling the gain used in gain varying section 30 based on the digital signal output from A/D converter 40, and updating the gain control signal at time intervals set on the basis of changes over time in the digital signal output from A/D converter 40. The gain used in gain varying section 30 is controlled on the basis of the gain control signal output from baseband signal processing section 50.

Baseband signal processing section 50 may also perform other signal processing functions required typically for reception in addition to the aforementioned functions.

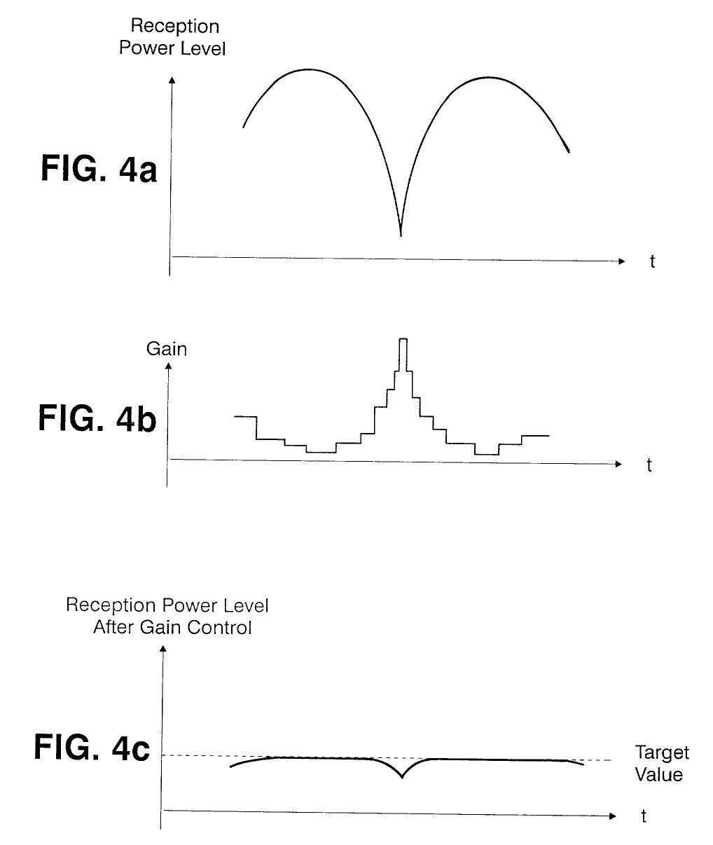

Description is hereinafter made for a reception gain control method in the mobile terminal configured as described above with reference to FIGS. 4a to 4c.

A signal received through antenna 10 and radio section 20 is input to gain varying section 30. Gain varying section 30 amplifies the input signal with gain based on the gain control signal output from baseband signal processing section 50 and outputs the amplified signal to A/D converter 40.

A/D converter 40 converts the signal output from gain varying section 30 to a digital signal before output.

The digital signal output from A/D converter 40 is input to baseband signal processing section 50 which performs baseband processing thereof. Baseband signal processing section 50 produces and updates the gain control signal for controlling the gain used in gain varying section 30 based on the current gain control signal and the digital signal output from A/D converter 40. In this update, the current reception power level is calculated on the basis of the current gain control signal and the digital signal output from A/D converter 40, and the change over time in the calculated reception power level is used to calculate the slope of the reception power level (a temporal differentiation value for changes over time in the reception signal level). Based on the absolute value thereof, a time interval for the update of the gain control signal is set.

Specifically, as shown in FIG. 4b, as an absolute value of the slope of the reception power level is larger, a shorter time interval for update of the gain control signal is set.

It is thus possible to cause the gain value to follow even an abrupt change in the reception power level. Consequently, as shown in FIG. 4c, an error between the reception power level after the gain control and a target value can be reduced.

It is contemplated that, for information on the current reception power level required for updating the gain control signal, the reception signal itself is supplied to baseband signal processing section 50 from radio section 20 and gain varying section 30 through A/D converter 40, for example, other than the aforementioned method.

While the time intervals for the gain control signal update may be continuously defined as described above, the slopes of the reception power level may discretely correspond to the time intervals for the update.

(Another Embodiment)

In another embodiment of the present invention, baseband signal processing section 50 calculates the current reception power level and calculates a difference or a ratio between the calculated reception power level and an average value of reception power levels of a long time period which is obtained by averaging variations in the reception power level of a sufficiently long time due to fading. Based on the resultant value, a time interval for updating the gain control signal is set.

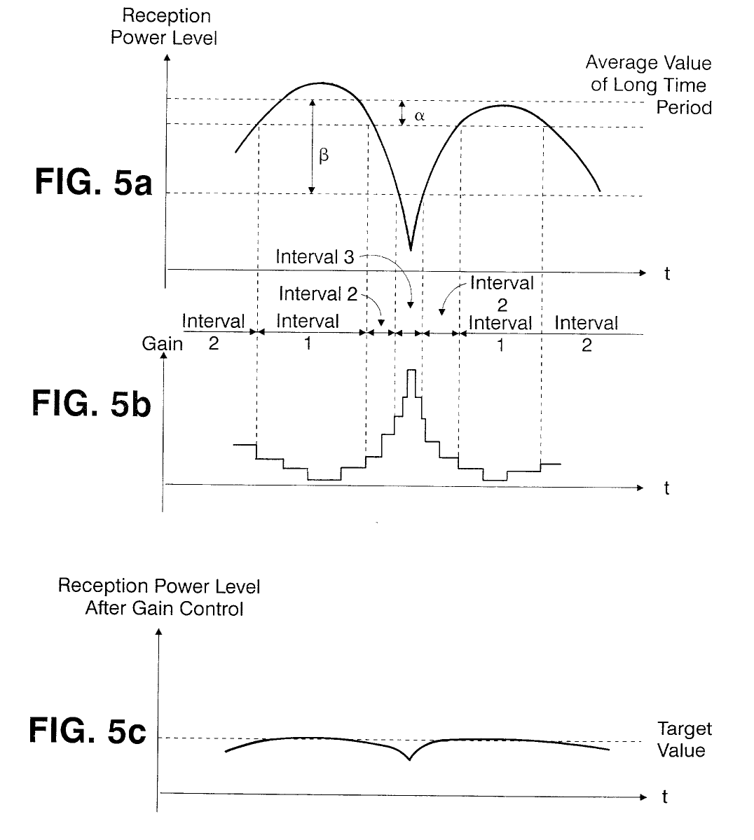

As shown in FIGS. 5a and 5b, when a value obtained with an equation (average value of reception power levels of long time period)−(reception power level) is less than threshold value á, the time interval for the gain control signal update is set to interval 1 which is the longest. When the value is equal to or larger than threshold value â, the time interval is set to the interval 3 which is the shortest. When the value is equal to or larger than threshold value á and less than threshold â, the time interval is set to interval 2 which is longer than interval 3 and shorter than interval 1.

It is possible that, instead of the aforementioned equation (average value of reception power levels of long time period)−(reception power level), an equation (average value of reception power levels of long time period)/(reception power level) can be used to realize control similar to the aforementioned one. In addition, while threshold values á and â are defined discretely in the example, continuous threshold values can be defined to continuously change the time intervals for the gain control signal update.

In this manner, even an abrupt change in the reception power level can be followed by the gain value. As a result, an error between the reception power level after the gain control and a target value can be reduced as shown in FIG. 5c.

Thus, the number bits resulting from quantization in the A/D converter can be reduced to achieve a smaller size and reduced power consumption of the entire device.

While preferred embodiments of the present invention have been described using specific terms, such description is for illustrative purposes only, and it is to be understood that changes and variations may be made without departing from the spirit or scope of the following claims.

What is claimed is:

1. A mobile terminal comprising:
a gain varying means for amplifying a received signal with gain controlled by a gain control signal and outputting the amplified signal;
an A/D converter for converting the signal output from said gain varying means into a digital signal and outputting the converted signal; and
a baseband signal processing means for performing baseband processing of the digital signal output from said A/D converter, producing said gain control signal based on the digital signal, and updating said gain control signal at time intervals set on the basis of a rate of change over time in a power level of said received signal.

2. The mobile terminal according to claim 1, wherein said baseband signal processing means sets a shorter time interval for update of said gain control signal as an absolute value of a slope of an amount of change in the power level of said received signal per unit time is larger.

3. A mobile terminal comprising:
a gain varying means for amplifying a received signal with gain controlled by a gain control signal and outputting the amplified signal;
an A/D converter for converting the signal output from said gain varying means into a digital signal and outputting the converted signal; and
a baseband signal processing means for performing baseband processing of the digital signal output from said A/D converter, producing said gain control signal based on the digital signal, and updating said gain control signal at time intervals set on the basis of a difference between a power level of said received signal and an average value of power levels of said received signal of a long time period.

4. A mobile terminal comprising:
a gain varying means for amplifying a received signal with gain controlled by a gain control signal and outputting the amplified signal;
an A/D converter for converting the signal output from said gain varying means into a digital signal and outputting the converted signal; and
a baseband signal processing means for performing baseband processing of the digital signal output from said A/D converter, producing said gain control signal based on the digital signal, and updating said gain control signal at time intervals set on the basis of a ratio of a power level of said received signal to an average value of power levels of said received signal of a long time period.

5. The mobile terminal according to claim 1, wherein said baseband signal processing means calculates the power level of said received signal on the basis of the gain control signal currently output and the digital signal output from said A/D converter.

6. The mobile terminal according to claim 2, wherein said baseband signal processing means calculates the power level of said received signal on the basis of the gain control signal currently output and the digital signal output from said A/D converter.

7. The mobile terminal according to claim 3, wherein said baseband signal processing means calculates the power level of said received signal on the basis of the gain control signal currently output and the digital signal output from said A/D converter.

8. The mobile terminal according to claim 4, wherein said baseband signal processing means calculates the power level of said received signal on the basis of the gain control signal currently output and the digital signal output from said A/D converter.

9. The mobile terminal according to claim 1, wherein said gain varying means has a gain control characteristic exhibiting linearly changes in gain represented by logarithm with respect to changes in said gain control signal.

10. The mobile terminal according to claim 2, wherein said gain varying means has a gain control characteristic exhibiting linearly changes in gain represented by logarithm with respect to changes in said gain control signal.

11. The mobile terminal according to claim 3, wherein said gain varying means has a gain control characteristic exhibiting linearly changes in gain represented by logarithm with respect to changes in said gain control signal.

12. The mobile terminal according to claim 4, wherein said gain varying means has a gain control characteristic exhibiting linearly changes in gain represented by logarithm with respect to changes in said gain control signal.

13. The mobile terminal according to claim 5, wherein said gain varying means has a gain control characteristic exhibiting linearly changes in gain represented by logarithm with respect to changes in said gain control signal.

14. The mobile terminal according to claim 6, wherein said gain varying means has a gain control characteristic exhibiting linearly changes in gain represented by logarithm with respect to changes in said gain control signal.

15. The mobile terminal according to claim 7, wherein said gain varying means has a gain control characteristic exhibiting linearly changes in gain represented by logarithm with respect to changes in said gain control signal.

16. The mobile terminal according to claim 8, wherein said gain varying means has a gain control characteristic exhibiting linearly changes in gain represented by logarithm with respect to changes in said gain control signal.

17. A method of controlling reception gain in a mobile terminal including gain varying means for amplifying a received signal with gain controlled by a gain control signal produced and updated on the basis of a power level of said received signal and outputting the amplified signal, comprising the step of:
setting a time interval for update of said gain control signal based on a rate of change over time in the power level of said received signal.

18. A method of controlling reception gain comprising the steps of:
calculating a power level of a received signal;
producing a gain control signal for controlling gain for amplifying said received signal based on said calculated power level;
calculating a rate of change over time in said calculated power level;
setting a time interval for update of said gain control signal based on the calculated rate of change over time in said calculated power level; and
updating said gain control signal with said set time interval.

19. The method of controlling reception gain according to claim 17, wherein as an absolute value of a slope of an amount of change in the power level of said reception signal per unit time is larger, a shorter time interval for update of said gain control signal is set.

20. The method of controlling reception gain according to claim 18, wherein as an absolute value of a slope of an amount of change in the power level of said reception signal per unit time is larger, a shorter time interval for update of said gain control signal is set.

21. A method of controlling reception gain in a mobile terminal including gain varying means for amplifying a received signal with gain controlled by a gain control signal produced and updated on the basis of a power level of said received signal and outputting the amplified signal, comprising the step of:
setting a time interval for update of said gain control signal based on a difference between the power level of said received signal and an average value of power levels of said received signal of a long time period.

22. A method of controlling reception gain comprising the steps of:
calculating a power level of a received signal;
producing a gain control signal for controlling gain for amplifying said received signal based on said calculated power level;
calculating a difference between said calculated power level and an average value of power levels of said received signal of a long time period;
setting a time interval for update of said gain control signal based on the calculated difference between said power level and the average value of power levels of said received signal of a long time period; and
updating said gain control signal with said set time interval.

23. A method of controlling reception gain in a mobile terminal including a gain varying means for amplifying a received signal with gain controlled by a gain control signal produced and updated on the basis of a power level of said received signal and outputting the amplified signal, comprising the step of:
setting a time interval for update of said gain control signal based on a ratio of the power level of said received signal to an average value of power levels of said received signal of a long time period.

24. A method of controlling reception gain comprising the steps of:
calculating a power level of a received signal;
producing a gain control signal for controlling gain for amplifying said received signal based on said calculated power level;
calculating a ratio of said calculated power level to an average value of power levels of said received signal of a long time period;
setting a time interval for update of said gain control signal based on the calculated ratio of said power level to the average value of power levels of said received signal of a long time period; and
updating said gain control signal with said set time interval.
